(19) United States
(12) Patent Application Publication
(10) Pub. No.: US 2022/0372668 A1
(43) Pub. Date: Nov. 24, 2022

(54) CORE-SHEATH COMPOSITE FIBER FOR ARTIFICIAL HAIR, HEADWEAR PRODUCT INCLUDING SAME, AND PRODUCTION METHOD FOR SAME

(71) Applicant: KANEKA CORPORATION, Osaka (JP)

(72) Inventor: Takashi Ogino, Osaka (JP)

(73) Assignee: KANEKA CORPORATION, Osaka (JP)

(21) Appl. No.: 17/881,867

(22) Filed: Aug. 5, 2022

Related U.S. Application Data
(63) Continuation of application No. PCT/JP2021/000044, filed on Jan. 5, 2021.

(30) Foreign Application Priority Data
Mar. 3, 2020 (JP) 2020-036164

(51) Int. Cl. D01F 8/14; D01F 8/12; D01D 5/34; D01D 5/253; D01D 5/08; D01D 5/24; B29C 48/05; B29C 48/09; B29C 48/00; B29C 48/21; A41G 3/00; A41G 5/00

(52) U.S. Cl. CPC D01F 8/14; D01F 8/12; D01D 5/34; D01D 5/253; D01D 5/08; D01D 5/24; B29C 48/05; B29C 48/09; B29C 48/022; B29C 48/21; A41G 3/00; A41G 5/004; D10B 2503/08; D10B 2331/04; D10B 2331/02; B29K 2077/00

(57) ABSTRACT

A core-sheath conjugate fiber for artificial hair including a core part and a sheath part is provided. The core part contains a polyester-based resin composition containing a polyester-based resin, and the sheath part contains a polyamide-based resin composition containing a polyamide-based resin. The core-sheath conjugate fiber for artificial hair has a core-to-sheath area ratio of core:sheath=2:8 to 8:2 and includes a hollow part, and the area of the hollow part constitutes 7% or more and 40% or less of the area of a fiber cross section. A core-sheath conjugate fiber for artificial hair that has a touch close to that of human hair and good voluminousness and curl setting property, and a hair ornament product including the same, and a method for producing the same are provided.

### TECHNICAL FIELD

One or more embodiments of the present invention relate to a core-sheath conjugate fiber for artificial hair capable of being used as an alternative to human hair, a hair ornament product including the same, and a production method therefor.

### BACKGROUND

Conventionally, human hair is used for hair ornament products such as hairpieces, hair wigs, hair extensions, hair bands, and doll hair. However, in recent years, it is becoming difficult to obtain human hair, and thus there is an increasing demand for artificial hair capable of being used as an alternative to human hair. Examples of synthetic fibers that can be used for artificial hair include acrylic-based fibers, vinyl chloride-based fibers, vinylidene chloride-based fibers, polyester-based fibers, polyamide-based fibers, and polyolefin-based fibers. Of these, Patent Document 1 proposes the use of a hollow fiber of vinyl chloride-based resin as a fiber for artificial hair and Patent Document 2 proposes the use of vinylidene chloride-based hollow yarns as a fiber for artificial hair to achieve voluminousness.

### PATENT DOCUMENT

Patent Document 1: JP 2007-009336A

Patent Document 2: JP 2008-007891A

However, the hollow fibers described in Patent Document 1 and Patent Document 2, their touch was quite different from that of human hair, although their voluminousness and curl setting property were good.

In order to address the above, one or more embodiments of the present invention provide a core-sheath conjugate fiber for artificial hair that has a touch close to that of human hair and whose voluminousness and curl setting property are good, a hair ornament product including the same, and a method for producing the same.

### SUMMARY

One or more embodiments of the present invention relate to a core-sheath conjugate fiber for artificial hair including a core part and a sheath part, wherein the core part is comprised of a polyester-based resin composition that contains a polyester-based resin, the sheath part is comprised of a polyamide-based resin composition that contains a polyamide-based resin, the core-sheath conjugate fiber for artificial hair has a core-to-sheath area ratio of core:sheath=2:8 to 8:2 and includes a hollow part, and in a fiber cross section, the area of the hollow part constitutes 7% or more and 40% or less of the area of the fiber cross section.

Furthermore, one or more embodiments of the present invention relate to a hair ornament product including the core-sheath conjugate fiber for artificial hair.

Furthermore, one or more embodiments of the present invention relate to a method for producing the core-sheath conjugate fiber for artificial hair, including a step of melt spinning the polyester-based resin composition and the polyamide-based resin composition using a core-sheath conjugate nozzle.

According to one or more embodiments of the present invention, it is possible to provide a core-sheath conjugate fiber for artificial hair that has a touch close to that of human hair and whose voluminousness and curl setting property are good, and a hair ornament product including the same.

According to the production method of one or more embodiments of the present invention, it is possible to obtain a core-sheath conjugate fiber for artificial hair that has a touch close to that of human hair and whose voluminousness and curl setting property are good.

### BRIEF DESCRIPTION OF THE DRAWINGS

FIG. 1 is a schematic view showing a fiber cross section of a core-sheath conjugate fiber for artificial hair according to an example of one or more embodiments of the present invention.

FIG. 2 is a schematic view showing a fiber cross section of a core-sheath conjugate fiber for artificial hair according to another example of one or more embodiments of the present invention.

FIG. 3 is laser microscopic photograph of a fiber cross section of a fiber of Example 1.

FIG. 4 is laser microscopic photograph of a fiber cross section of a fiber of Example 5.

### DETAILED DESCRIPTION

The inventor of one or more embodiments of the present invention conducted an in-depth research in order to address the above, and found that, when a polyester-based resin composition is used for a core part and a polyamide-based resin composition is used for a sheath part in a core-sheath conjugate fiber having a core-sheath structure and the core-sheath conjugate fiber has a predetermined core-to-sheath area ratio and a predetermined hollow part percentage, the core-sheath conjugate fiber has a touch close to that of human hair and voluminousness and the curl setting property of the fiber are good, and thus one or more embodiments of the present invention were achieved.

### Shape of Core-Sheath Conjugate Fiber

The core-sheath conjugate fiber for artificial hair (hereinafter also simply referred to as “core-sheath conjugate fiber”) includes a core part, a sheath part, and a hollow part. It is preferable that, in a fiber cross section, the core part is inside the sheath part and the hollow part is inside the core part. The core-sheath conjugate fiber may have a concentric structure in which the center point of the core part and the center point of the hollow part coincide with the center point of the fiber, or an eccentric structure in which the center point of the core part and the center point of the hollow part do not coincide with the center point of the fiber and are situated away therefrom. Alternatively, a configuration is also possible in which the center point of the core part coincides with the center point of the fiber, but the center point of the hollow part does not coincide with the center point of the fiber. From the viewpoint of spinning stability and the curl setting property, the core-sheath conjugate fiber may have the concentric structure in which the center point of the core part and the center point of the hollow part coincide with the center point of the fiber. In order to prevent the core part and the sheath part from separating from each other, it is preferable that, in a fiber cross section of the core-sheath conjugate fiber for artificial hair, the core part is completely covered by the sheath part without being exposed to the fiber surface.

The cross sectional shape of the core-sheath conjugate fiber for artificial hair may be a circular shape or any other shape. Examples of other shapes include an elliptical shape and a multilobed shape such as a flat two-lobed shape. Also, the cross sectional shapes of the core part and the hollow part may be circular shapes or any other shape.

Examples of other shapes include an elliptical shape and a multilobed shape such as a flat two-lobed shape. From the viewpoint of voluminousness, the curl setting property, and touch, the cross sectional shapes of the core-sheath conjugate fiber for artificial hair, the core part, and the hollow part may be elliptical shapes. The cross sectional shape of the core-sheath conjugate fiber for artificial hair may be the same as or differ from the cross sectional shape of the core part. From the viewpoint of the touch, gloss, combing property, and the like, the cross sectional shape of the core part may be a modified flat two-lobed shape or a modified elliptical shape including a pair of protrusions protruding from the center side toward the outer circumferential side along a minor axis direction in the fiber cross section.

In a flat two-lobed shape, two lobal portions having a shape selected from the group consisting of a circular shape and an elliptical shape are connected via recessed portions. The circular or elliptical shape does not absolutely have to be a continuous arc, and may also be a substantially circular shape or a substantially elliptical shape that is partially deformed, as long as no acute angle is formed.

The modified flat two-lobed shape is obtained by modifying the flat two-lobed shape so as to include a pair of protrusions protruding from the center side toward the outer circumferential side along a minor axis direction in the fiber cross section. In the flat two-lobed shape, two lobal portions having a shape selected from the group consisting of a circular shape and an elliptical shape are connected via recessed portions, whereas in the modified flat two-lobed shape, the two lobal portions having a shape selected from the group consisting of a circular shape and an elliptical shape are connected via the protrusions.

Regarding the cross sectional shapes, no consideration is given to asperities with a size of 2 μm or less generated at the outer circumference of the fiber and the outer circumference of the core part due to an additive or the like that may be contained in the core-sheath conjugate fiber for artificial hair according to one or more embodiments of the present invention.

In the fiber cross section of the core-sheath conjugate fiber for artificial hair, the percentage (hollow part percentage) of the area of the hollow part relative to the area of the fiber cross section is 7% or more and 40% or less. If the hollow part percentage is lower than 7%, the weight of the fiber is not sufficiently reduced when compared with a fiber that does not have a hollow structure, and the desired voluminousness cannot be obtained. If the hollow part percentage is higher than 40%, there is a risk that an extremely thin portion or a discontinuous portion will be formed in the core part or the sheath part, leading to generation of a crack or a split from that portion.

The above-described cross sectional shapes of the fiber, the core part, and the hollow part, and the core-to-sheath area ratio can be controlled by using a nozzle (pores) with a shape close to the target cross sectional shape.

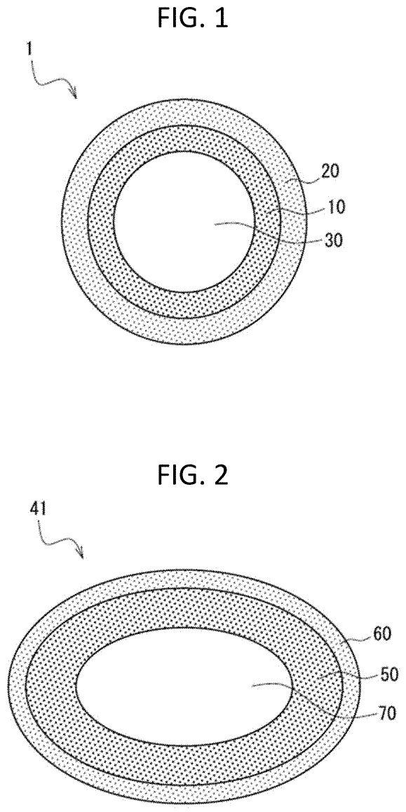

FIG. 1 is a schematic view showing a cross section of a core-sheath conjugate fiber for artificial hair according to an example of one or more embodiments of the present invention. The core-sheath conjugate fiber 1 for artificial hair includes a core part 10, a sheath part 20, and a hollow part 30. The core-sheath conjugate fiber 1 has a concentric structure in which the core part 10 and the hollow part 30 are concentrically arranged such that the center points of the core part 10 and the hollow part 30 coincide with the center point of the core-sheath conjugate fiber 1, and the cross sectional shapes of the core-sheath conjugate fiber 1, the core part 10, and the hollow part 30 are all circular shapes.

FIG. 2 is a schematic view showing a cross section of a core-sheath conjugate fiber for artificial hair according to another example of one or more embodiments of the present invention. The core-sheath conjugate fiber 41 for artificial hair includes a core part 50, a sheath part 60, and a hollow part 70. The core-sheath conjugate fiber 41 have a concentric structure in which the core part 50 and the hollow part 70 are concentrically arranged such that the center points of the core part 50 and the hollow part 70 coincide with the center point of the core-sheath conjugate fiber 41, and the cross sectional shapes of the core-sheath conjugate fiber 41, the core part 50, and the hollow part 70 are all elliptical shapes.

The core-to-sheath area ratio of the core-sheath conjugate fiber for artificial hair is in the range of core:sheath=2:8 to 8:2. If the core-to-sheath area ratio is in this range, the value of bending rigidity, which is a physical property relating to the touch, texture, and the like, is close to that of human hair, and thus a core-sheath conjugate fiber for artificial hair with a quality similar to that of human hair can be obtained. If the ratio of the core part is lower than this range, the bending rigidity value becomes smaller than that of human hair, and thus artificial hair with a quality similar to that of human hair cannot be obtained, and an extremely thin portion or a discontinuous portion is formed in the core part, leading to generation of a crack or a split from that portion. On the other hand, if the ratio of the core part is higher than this range, the bending rigidity value becomes too large and is not close to that of human hair, and, moreover, the sheath is so thin that the core is likely to be exposed. From the viewpoint of obtaining a touch, texture, and the like close to those of human hair, the core-to-sheath area ratio of the core-sheath conjugate fiber for artificial hair may be in the range of core:sheath=3:7 to 7:3, or in the range of 4:6 to 6:4.

From the viewpoint of suitability for artificial hair, the core-sheath conjugate fiber for artificial hair may have a single fiber fineness of 10 dtex or more and 150 dtex or less, 30 dtex or more and 120 dtex or less, 40 dtex or more and 100 dtex or less, or 50 dtex or more and 90 dtex or less.

In a mass of the core-sheath conjugate fibers for artificial hair, e.g., a fiber bundle of the core-sheath conjugate fibers for artificial hair, all fibers do not necessarily have to have the same fineness and the same cross sectional shape, and fibers having different values of fineness and different cross sectional shapes may be mixed.

Composition of Core-Sheath Conjugate Fiber

The core part is comprised of a polyester-based resin composition that contains a polyester-based resin, i.e., a polyester-based resin composition containing a polyester-based resin as a main component. When the total weight of the polyester-based resin composition containing a polyester-based resin as a main component is taken as 100% by weight, the polyester-based resin composition contains the polyester-based resin in an amount of more than 50% by weight, preferably 70% by weight or more, even more preferably 80% by weight or more, even more preferably 90% by weight or more, and even more preferably 95% by weight or more.

It is preferable to use, as the polyester-based resin, one or more of polyester-based resins selected from the group consisting of polyalkylene terephthalate and a copolymerized polyester mainly containing polyalkylene terephthalate. The “copolymerized polyester mainly containing polyalkylene terephthalate” refers to a copolymerized polyester containing polyalkylene terephthalate in an amount of 80 mol % or more.

Polyalkylene terephthalate is not particularly limited, and may be, for example, polyethylene terephthalate, polypropylene terephthalate, polybutylene terephthalate, or polycyclohexane dimethylene terephthalate.

The copolymerized polyester mainly containing polyalkylene terephthalate is not particularly limited, and may be, for example, a copolymerized polyester mainly containing polyalkylene terephthalate such as polyethylene terephthalate, polypropylene terephthalate, polybutylene terephthalate, or polycyclohexane dimethylene terephthalate, and further containing other copolymerizable components.

Examples of the other copolymerizable components include: polycarboxylic acids such as isophthalic acid, orthophthalic acid, naphthalenedicarboxylic acid, paraphenylenedicarboxylic acid, trimellitic acid, pyromellitic acid, succinic acid, glutaric acid, adipic acid, suberic acid, azelaic acid, sebacic acid, and dodecanedioic acid, and their derivatives; dicarboxylic acids and their derivatives containing sulfonates such as 5-sodiumsulfoisophthalic acid and dihydroxyethyl 5-sodiumsulfoisophthalate; 1,2-propanediol; 1,3-propanediol; 1,4-butanediol; 1,6-hexanediol; neopentyl glycol; 1,4-cyclohexanedimethanol; diethylene glycol; polyethylene glycol; trimethylolpropane; pentaerythritol; 4-hydroxybenzoic acid; ϵ-caprolactone; and an ethylene glycol ether of bisphenol A.

The copolymerized polyester may be produced by adding a small amount of other copolymerizable components to polyalkylene terephthalate serving as a main component, and allowing them to react with each other, from the viewpoint of stability and ease of operation. Examples of the polyalkylene terephthalate include a polymer of terephthalic acid and/or its derivatives (e.g., methyl terephthalate) and alkylene glycol. The copolymerized polyester may be produced by adding a small amount of monomer or oligomer component serving as other copolymerizable components, to a mixture of terephthalic acid and/or its derivatives (e.g., methyl terephthalate) and alkylene glycol, used for polymerization of polyalkylene terephthalate serving as a main component, and subjecting them to polymerization.

It is sufficient that the copolymerized polyester has a structure in which the other copolymerizable components are polycondensed on the main chain and/or side chain of polyalkylene terephthalate serving as a main component, and the copolymerization method and the like are not particularly limited.

Specific examples of the copolymerized polyester mainly containing polyalkylene terephthalate include a polyester obtained through copolymerization of polyethylene terephthalate serving as a main component with one compound selected from the group consisting of an ethylene glycol ether of bisphenol A, 1,4-cyclohexanedimethanol, isophthalic acid, and dihydroxyethyl 5-sodiumsulfoisophthalate.

Polyalkylene terephthalate and the copolymerized polyester mainly containing polyalkylene terephthalate may be used alone or in a combination of two or more. In particular, polyethylene terephthalate; polypropylene terephthalate; polybutylene terephthalate; a polyester obtained through copolymerization of polyethylene terephthalate serving as a main component with an ethylene glycol ether of bisphenol A; a polyester obtained through copolymerization of polyethylene terephthalate serving as a main component with 1,4-cyclohexanedimethanol; a polyester obtained through copolymerization of polyethylene terephthalate serving as a main component with isophthalic acid; a polyester obtained through copolymerization of polyethylene terephthalate serving as a main component with dihydroxyethyl 5-sodiumsulfoisophthalate, and the like may be used alone or in a combination of two or more.

The intrinsic viscosity (alternatively referred to as “IV value”) of the polyester-based resin is not particularly limited, but may be 0.3 or more and 1.2 or less, or 0.4 or more and 1.0 or less. If the intrinsic viscosity is 0.3 or more, the mechanical strength of the obtained fiber does not decrease, and there is no risk of dripping during a combustion test. On the other hand, if the intrinsic viscosity is 1.2 or less, the molecular weight is not too large, and the melt viscosity is not too high, and thus it is easy to perform melt spinning, and the fineness is likely to be uniform.

The polyester-based resin composition may further contain other resins in addition to the polyester-based resin. Examples of the other resins include a polyamide-based resin, a vinyl chloride-based resin, a modacrylic-based resin, a polycarbonate-based resin, a polyolefin-based resin, and a polyphenylenesulfi de-based resin. These resins may be used alone or in a combination of two or more.

The sheath part is comprised of a polyamide-based resin composition that contains a polyamide-based resin, i.e., a polyamide-based resin composition containing a polyamide-based resin as a main component. When the total weight of the polyamide-based resin composition containing a polyamide-based resin as a main component is taken as 100% by weight, the polyamide-based resin composition contains the polyamide-based resin in an amount of more than 50% by weight, preferably 70% by weight or more, even more preferably 80% by weight or more, even more preferably 90% by weight or more, and even more preferably 95% by weight or more.

The polyamide-based resin means a nylon resin obtained through polymerization of one or more selected from the group consisting of lactam, aminocarboxylic acid, a mixture of dicarboxylic acid and diamine, a mixture of a dicarboxylic acid derivative and diamine, and a salt of dicarboxylic acid and diamine.

Specific examples of the lactam include, but are not particularly limited to, for example, 2-azetidinone, 2-pyrrolidinone, 6-valerolactam, ϵ-caprolactam, enantholactam, capryllactam, undecalactam, and laurolactam. Of these lactams, it is preferable to use ϵ-caprolactam, undecalactam, and laurolactam, and more preferable to use ϵ-caprolactam. These lactams may be used alone or in a combination of two or more.

Specific examples of the aminocarboxylic acid include, but are not particularly limited to, for example, 6-aminocaproic acid, 7-aminoheptanoic acid, 8-aminooctanoic acid, 9-aminononanoic acid, 10-aminodecanoic acid, 11-aminoundecanoic acid, and 12-aminododecanoic acid. Of these aminocarboxylic acids, it is preferable to use 6-aminocaproic acid, 11-aminoundecanoic acid, and 12-aminododecanoic acid, and more preferable to use 6-aminocaproic acid. These aminocarboxylic acids may be used alone or in a combination of two or more.

Specific examples of the dicarboxylic acid that can be used for the mixture of dicarboxylic acid and diamine, the mixture of a dicarboxylic acid derivative and diamine, or the salt of dicarboxylic acid and diamine include, but are not particularly limited to, for example: aliphatic dicarboxylic acids such as oxalic acid, malonic acid, succinic acid, glutaric acid, adipic acid, pimelic acid, suberic acid, azelaic acid, sebacic acid, undecanedioic acid, dodecanedioic acid, brasylic acid, tetradecanedioic acid, pentadecanedioic acid, and octadecanedioic acid; alicyclic dicarboxylic acids such as cyclohexane dicarboxylic acid; and aromatic dicarboxylic acids such as phthalic acid, isophthalic acid, terephthalic acid, and naphthalenedicarboxylic acid. Of these dicarboxylic acids, it is preferable to use adipic acid, sebacic acid, dodecanedioic acid, terephthalic acid, and isophthalic acid, and more preferable to use adipic acid, terephthalic acid, and isophthalic acid. These dicarboxylic acids may be used alone or in a combination of two or more.

Specific examples of the diamine that can be used for the mixture of dicarboxylic acid and diamine, the mixture of a dicarboxylic acid derivative and diamine, or the salt of dicarboxylic acid and diamine include, but are not particularly limited to, for example: aliphatic diamines such as 1,4-diaminobutane, 1,5-diaminopentane, 1,6-diaminohexane, 2-methyl-1,5-diaminopentane (MDP), 1, 7-diaminoheptane, 1,8-diaminooctane, 1,9-diaminononan, 1,10-diaminodecane, 1,11-diaminoundecane, 1,12-diaminododecane, 1,13-diaminotridecane, 1,14-diaminotetradecane, 1,15-diaminopentadecane, 1,16-diaminohexadecane, 1,17-diaminoheptadecane, 1,18-diaminooctadecane, 1,19-diaminononadecane, and 1,20-diaminoeicosane; alicyclic diamines such as cyclohexanediamine and bis-(4-aminohexyl)methane; and aromatic diamines such as m-xylylenediamine and p-xylylenediamine. Of these diamines, it is preferable to use an aliphatic diamine, and more preferable to use hexamethylenediamine. These diamines may be used alone or in a combination of two or more.

The polyamide-based resin (alternatively referred to as a “nylon resin”) is not particularly limited, but it is preferable to use, for example, Nylon 6, Nylon 66, Nylon 11,

Nylon 12, Nylon 6/10, Nylon 6/12, semi-aromatic nylon containing the Nylon 6T and/or 61 unit, copolymers of these nylon resins, or the like. It is more preferable to use Nylon 6, Nylon 66, or a copolymer of Nylon 6 and Nylon 66.

The polyamide-based resin can be produced for example, using a polyamide-based resin polymerization method in which a raw material for the polyamide-based resin is heated in the presence or absence of a catalyst. During the polymerization, stirring may or may not be performed, but it is preferable to perform stirring in order to obtain a uniform product. The polymerization temperature can be set as appropriate according to the degree of polymerization, the reaction yield, and the reaction time of a target polymer, but it is preferable to set the temperature to a low temperature in consideration of the quality of a finally obtained polyamide-based resin. The reaction ratio can also be set as appropriate. The pressure is not limited, but it is preferable to reduce the pressure in the system in order to efficiently let volatile components move to the outside of the system.

The polyamide-based resin may have a terminal end that is capped by an end-capping agent such as a carboxylic acid compound or an amine compound as necessary. The concentration of terminal amino groups or terminal carboxyl groups in a nylon resin obtained when a terminal end is capped by adding monocarboxylic acid or monoamine is lower than that when such an end-capping agent is not used. On the other hand, the total concentration of terminal amino groups and terminal carboxyl groups does not change when a terminal end is capped by dicarboxylic acid or diamine, but the concentration ratio between terminal amino groups and terminal carboxyl groups changes.

Specific examples of the carboxylic acid compound include, but are not particularly limited to, for example: aliphatic monocarboxylic acids such as acetic acid, propionic acid, butyric acid, valeric acid, caproic acid, enanthic acid, caprylic acid, pelargonic acid, undecanoic acid, lauric acid, tridecanoic acid, myristic acid, myristoleic acid, palmitic acid, stearic acid, oleic acid, linoleic acid, and arachic acid; alicyclic monocarboxylic acids such as cyclohexanecarboxylic acid and methylcyclohexanecarboxylic acid; aromatic monocarboxylic acids such as benzoic acid, toluic acid, ethylbenzoic acid, and phenylacetic acid; aliphatic dicarboxylic acids such as oxalic acid, malonic acid, succinic acid, glutaric acid, adipic acid, pimelic acid, suberic acid, azelaic acid, sebacic acid, undecanedioic acid, dodecanedioic acid, brasylic acid, tetradecanedioic acid, pentadecanedioic acid, and octadecanedioic acid; alicyclic dicarboxylic acids such as cyclohexanedicarboxylic acid; and aromatic dicarboxylic acids such as phthalic acid, isophthalic acid, terephthalic acid, and naphthalenedicarboxylic acid.

Specific examples of the amine compound include, but are not particularly limited to, for example: aliphatic monoamines such as butylamine, pentylamine, hexylamine, heptylamine, octylamine, 2-ethylhexylamine, nonylamine, decylamine, undecylamine, dodecylamine, tridecylamine, tetradecylamine, pentadecylamine, hexadecylamine, octadecylamine, nonadecylamine, and icosylamine; alicyclic monoamines such as cyclohexylamine and methylcyclohexylamine; aromatic monoamines such as benzylamine and β-phenylethylamine; aliphatic diamines such as 1,4-diaminobutane, 1,5-diaminopentane, 1,6-diaminohexane, 1,7-diaminoheptane, 1,8-diaminooctane, 1,9-diaminononan, 1,10-diaminodecane, 1,11-diaminoundecane, 1,12-diaminododecane, 1,13-diaminotridecane, 1,14-diaminotetradecane, 1,15-diamino pentadecane, 1,16-diaminohexadecane, 1,17-diaminoheptadecane, 1,18-diaminooctadecane, 1,19-diaminononadecane, and 1,20-diaminoeicosane; alicyclic diamines such as cyclohexanediamine and bis-(4-aminohexyl)methane; and aromatic diamines such as xylylenediamine.

The terminal group concentration of the polyamide-based resin is not particularly limited, but the terminal amino group concentration may be high, for example, when it is necessary to increase the dyeability for fiber uses or when designing a material suitable for alloying for resin uses. On the other hand, the terminal amino group concentration may be low, for example, when it is required to suppress coloring or gelation under extended aging conditions. Furthermore, the terminal carboxyl group concentration and the terminal amino group concentration may be both low when it is required to suppress reproduction of lactam during re-melting, yarn breakage during melt spinning due to production of oligomer, mold deposit during continuous injection molding, and generation of die marks during continuous extrusion of a film. It is preferable to adjust the terminal group concentration according to the applications, but the terminal amino group concentration and the terminal carboxyl group concentration both may be 1.0×10⁻⁵ to 15.0×10⁻⁵ eq/g, 2.0×10⁻⁵ to 12.0×10⁻⁵ eq/g, or 3.0×10⁻⁵ to 11.0×10⁻⁵ eq/g.

Furthermore, the end-capping agent may be added using a method in which the end-capping agent is added simultaneously with raw materials such as caprolactam at the initial stage of polymerization, a method in which the end-capping agent is added during polymerization, a method in which the end-capping agent is added when a nylon resin in a molten state is caused to pass through a vertical stirring thin-film evaporator, or the like. The end-capping agent may be added without any treatment, or in the form of being dissolved in a small amount of solvent.

The polyamide-based resin composition may further contain other resins in addition to the polyamide-based resin. Examples of the other resins include a vinyl chloride-based resin, a modacrylic-based resin, a polycarbonate-based resin, a polyolefin-based resin, and a polyphenylenesulfide-based resin. These resins may be used alone or in a combination of two or more.

From the viewpoint of obtaining a touch and appearance closer to those of human hair and further improving the curling properties and curl retention properties, it is preferable that the core part of the core-sheath conjugate fiber for artificial hair is comprised of a polyester-based resin composition containing, as a main component, one or more of polyester-based resins selected from the group consisting of polyalkylene terephthalate and a copolymerized polyester mainly containing polyalkylene terephthalate, and it is more preferable that the sheath part of the core-sheath conjugate fiber for artificial hair is comprised of a polyamide-based resin composition containing, as a main component, a polyamide-based resin mainly containing at least one selected from the group consisting of Nylon 6 and Nylon 66. The “polyamide-based resin mainly containing at least one selected from the group consisting of Nylon 6 and Nylon 66” means a polyamide-based resin that contains Nylon 6 and/or Nylon 66 in an amount of 80 mol % or more.

From the viewpoint of flame retardance, a flame retardant may be used in the core-sheath conjugate fiber for artificial hair. Examples of the flame retardant include a bromine-containing flame retardant and a phosphorus-containing flame retardant. Examples of the phosphorus-containing flame retardant include a phosphoric acid ester amide compound and an organic cyclic phosphorus-based compound. Examples of bromine-based flame retardants include, but are not particularly limited to, for example: a brominated epoxy-based flame retardant; bromine-containing phosphoric acid esters such as pentabromotoluene, hexabromobenzene, decabromodiphenyl, decabromodiphenyl ether, bis(tribromophenoxy)ethane, tetrabromophthalic anhydride, ethylene bis(tetrabromophthalimide), ethylene bis(pentabromophenyl), octabromotrimethylphenylindan, and tris(tribromoneopentyl)phosphate; brominated polystyrenes; brominated polybenzyl acrylates; a brominated phenoxy resin; brominated polycarbonate oligomers; tetrabromobisphenol A and tetrabromobisphenol A derivatives such as tetrabromobisphenol A-bis(2,3-dibromopropyl ether), tetrabromobisphenol A-bis(allylether), and tetrabromobisphenol A-bis(hydroxyethyl ether); bromine-containing triazine compounds such as tris(tribromophenoxy)triazine; and bromine-containing isocyanuric acid compounds such as tris(2,3-dibromopropyl)isocyanurate. Of these compounds, it is preferable to use a brominated epoxy-based flame retardant from the viewpoint of heat resistance and flame retardance.

A brominated epoxy-based flame retardant having an epoxy group or tribromophenol at a molecular end thereof may be used as a raw material. The structure of the brominated epoxy-based flame retardant after melt kneading is not particularly limited, but it is preferable that 80 mol % or more of the structure is comprised of a constituent unit represented by the chemical formula (1) below when the total number of constituent units each represented by the chemical formula (1) below and constituent units obtained by at least partially modifying the chemical formula (1) below is taken as 100 mol %. The structure of the brominated epoxy-based flame retardant may change at a molecular end thereof after melt kneading. For example, a molecular end of the brominated epoxy-based flame retardant may be substituted by a hydroxyl group, a phosphate group, a phosphonic acid group, or the like other than an epoxy group or tribromophenol, or may be bound to a polyester component through an ester group.

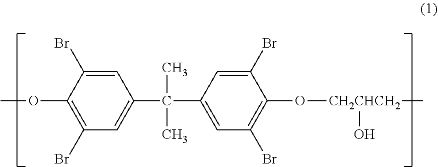

Furthermore, part of the structure of the brominated epoxy-based flame retardant, other than the molecular end, may be changed. For example, the brominated epoxy-based flame retardant may have a branched structure in which the secondary hydroxyl group and the epoxy group are bound. Also, part of the bromine of the chemical formula (1) above may be eliminated or added, as long as the bromine content in the molecules of the brominated epoxy-based flame retardant does not change significantly.

For example, a polymeric brominated epoxy-based flame retardant as represented by the general formula (2) below may be used as the brominated epoxy-based flame retardant. In the general formula (2) below, m is 1 to 1000. Examples of the polymeric brominated epoxy-based flame retardant represented by the general formula (2) below include a commercially available product such as a brominated epoxy-based flame retardant (product name “SR-T2MP”) manufactured by Sakamoto Yakuhin Kogyo Co., Ltd.

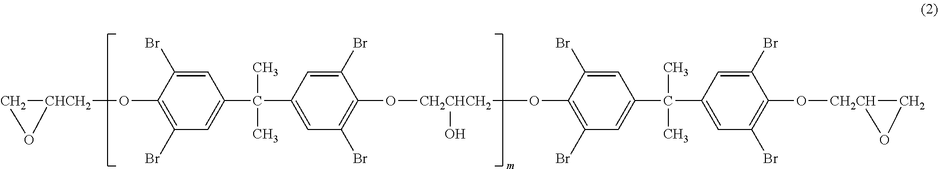

For example, it is preferable that the core part and/or the sheath part contains a bromine-based epoxy flame retardant in an amount of 5 parts by weight or more and 40 parts by weight or less with respect to 100 parts by weight of the main component resin, although there is no limitation thereto. For example, from the viewpoint of heat resistance and flame retardance, it is preferable that the core part is comprised of a polyester-based resin composition that contains 100 parts by weight of one or more of polyester-based resins selected from the group consisting of polyalkylene terephthalate and a copolymerized polyester mainly containing polyalkylene terephthalate and 5 parts by weight or more and 40 parts by weight or less of a bromine-based epoxy flame retardant, and the sheath part is comprised of a polyamide-based resin composition that contains 100 parts by weight of a polyamide-based resin mainly containing at least one selected from the group consisting of Nylon 6 and Nylon 66 and 5 parts by weight or more and 40 parts by weight or less of a bromine-based epoxy flame retardant.

A flame retardant auxiliary may be used in combination. The flame retardant auxiliary is not particularly limited, but it is preferable to use an antimony-based compound and a composite metal including antimony from the viewpoint of flame retardance. Examples of the antimony-based compound include antimony trioxide, antimony tetraoxide, antimony pentoxide, sodium antimonate, potassium antimonate, and calcium antimonate. It is more preferable to use one or more selected from the group consisting of antimony trioxide, antimony pentoxide, and sodium antimonate, from the viewpoint of improving the flame retardance and the influence on a touch.

For example, it is preferable that the core part and/or the sheath part contains the flame retardant auxiliary in an amount of 0.1 parts by weight or more and 10 parts by weight or less with respect to 100 parts by weight of the main component resin, although there is no limitation thereto.

In particular, when the polyamide-based resin composition constituting the sheath part contains the flame retardant auxiliary, appropriate asperities are formed on the surface of the fiber, and a core-sheath conjugate fiber for artificial hair having an appearance with a low gloss close to that of human hair as well as flame retardance is likely to be obtained.

As necessary, the core-sheath conjugate fiber for artificial hair may contain various types of additives such as a heat-resistant agent, a stabilizer, a fluorescer, an antioxidant, and an antistatic agent, within a range that does not inhibit the effects of one or more embodiments of the present invention.

### Method for Producing Core-Sheath Conjugate Fiber

It is possible to produce the core-sheath conjugate fiber for artificial hair by melt-kneading each of the resin compositions constituting the core part and the sheath part using various types of ordinary kneaders, and then performing melt spinning using a hollow nozzle for core-sheath conjugate spinning. For example, a core component is prepared by dry blending components such as the above-described polyester-based resin and the brominated epoxy-based flame retardant, and melt-kneading the obtained polyester-based resin composition using any of various ordinary kneaders. On the other hand, a sheath component is prepared by dry blending components such as the above-described polyamide-based resin, pigments, and the brominated epoxy-based flame retardant, and melt-kneading the obtained polyamide-based resin composition using any of various ordinary kneaders. The core-sheath conjugate fiber can be produced by melt spinning the core component and the sheath component using a hollow nozzle for core-sheath conjugate spinning. Examples of the kneaders include a single-screw extruder, a twin-screw extruder, a roll, a Banbury mixer, and a kneader. Of these kneaders, it is preferable to use a twin-screw extruder from the viewpoint of adjusting the kneading degree and easily performing the operation.

As the method for producing the fiber of one or more embodiments of the present invention, it is preferable to use a melt spinning method, and, for example, in the case of a polyester-based resin composition, melt spinning is performed while the temperatures of an extruder, a gear pump, a nozzle, and the like are set to 250° C. or more and 300° C. or less, and in the case of a polyamide-based resin composition, melt spinning is performed while the temperatures of an extruder, a gear pump, a nozzle, and the like are set to 260° C. or more and 320° C. or less, after which the extruded yarns are cooled to a temperature not higher than the glass transition points of the resins, and wound up at a speed of 50 m/min or more and 5000 m/min or less, and thus extruded yarns (undrawn yarns) are obtained.

Specifically, during the melt spinning, the polyester-based resin composition that constitutes the core part is supplied from a core-part extruder of a melt spinning machine, the polyamide-based resin composition that constitutes the sheath part is supplied from a sheath-part extruder of the melt spinning machine, a molten polymer is discharged from a hollow nozzle for core-sheath conjugate spinning with a predetermined shape, and thus extruded yarns (undrawn yarns) are obtained.

It is preferable that the extruded yarns (undrawn yarns) are hot drawn. The drawing may be performed by either a two-step method or a direct drawing method. In the two-step method, the extruded yarns are wound once, and then drawn. In the direct drawing method, the extruded yarns are drawn continuously without winding. The hot drawing may be performed by a single-stage drawing method or a multi-stage drawing method that includes two or more stages.

The heating means for the hot drawing may be a heating roller, a heat plate, a steam jet apparatus, or a hot water bath, which can be used in combination as desired.

It is also possible to make the touch and texture closer to those of human hair, by adding an oil solution such as a fiber treating agent and a softener to the core-sheath conjugate fiber for artificial hair. Examples of the fiber treating agent include a silicone-based fiber treating agent and a non-silicone-based fiber treating agent for improving the touch and the combing property.

The core-sheath conjugate fiber for artificial hair may be subjected to gear crimping. In this case, it is possible to make the fiber gently curved and have a natural appearance, and to reduce the contact between fibers, thereby improving the combing property. In the gear crimping, typically, a fiber heated to the softening temperature or more is caused to pass through a portion between two meshing gears, so that the shape of the gears is transferred to the fiber, and the fiber is thus curved. Furthermore, as necessary, it is also possible to make a fiber curled in different shapes by heat-treating the core-sheath conjugate fiber for artificial hair at different temperatures during the fiber treatment processes.

### Hair Ornament Product

The core-sheath conjugate fiber for artificial hair can be used for hair ornament products without particular limitation. For example, it is possible to use the core-sheath conjugate fiber for hair wigs, hairpieces, weaving hair, hair extensions, braided hair, hair accessories, doll hair, and the like.

The hair ornament product may be constituted only by the core-sheath conjugate fiber for artificial hair of one or more embodiments of the present invention. Alternatively, the hair ornament product may be comprised of the core-sheath conjugate fiber for artificial hair of one or more embodiments of the present invention combined with other fibers for artificial hair and natural fibers such as human hair and animal hair.

### EXAMPLES

Hereinafter, one or more embodiments of the present invention will be more specifically described by way of examples. Note that one or more embodiments of the present invention are not limited to these examples.

The measuring methods and the evaluation methods used in the examples and comparative examples are as follows.

### Shape of Fiber Cross Section

Fibers were bundled at room temperature (23° C.) and fixed with a shrinkage tube such that the fiber bundle (total fineness: 550 dtex) was not displaced, after which the bundle was cut in round slices using a cutter, and thus a fiber bundle for cross section observation was prepared. An image of this fiber bundle was captured using a laser microscope (“VK-9500” manufactured by Keyence Corporation) at a magnification of 500 times, and thus a photograph of a fiber cross section was obtained. The shape of the hollow part, the area of the hollow part, the area of the core part, the area of the sheath part, and the area of the fiber cross section (the total area of the hollow part, the core part, and the sheath part) were measured using the photograph, and the hollow part percentage (area of the hollow part/area of the fiber cross section×100) and the core-to-sheath area ratio (area of the core part:area of the sheath part) were evaluated.

### Voluminousness

The appearance of a fiber bundle sample of fibers for artificial hair and resilience of the fiber bundle sample when grasped were evaluated in three stages below based on a standard level by general engineers who engaged in beauty evaluation of hairpieces and the like. The standard level was determined by evaluating voluminousness using a bundle of natural human hair (Chinese person's hair).

A: Compared with the standard level, voluminousness of the sample is excellent in terms of both appearance and resilience even at the same weight.
B: Voluminousness of the sample is similar to the standard level.
C: Compared with the standard level, voluminousness of the sample is apparently poor at the same weight.

### Curl Setting Property

Filaments formed into a hair weft were wound around a pipe with a diameter of φ32 mm at room temperature (23° C.), and curls were set for 60 minutes at 120° C. and aged for 60 minutes at room temperature. Then, ends on one side of the curled filaments were fixed to suspend the filaments, and the length of the filaments after the curl setting was measured. The length was taken as an index of the curl setting property and evaluated in three stages below.

A: Less than 15 cm
B: 15 cm or more and less than 17 cm
C: 17 cm or more

### Yarn Breakage

If yarn breakage occurred once or more times during a continuous operation performed for 1 hour in the spinning process, the result is shown as “Yes”.

Crack and Split

10 fibers randomly selected from a fiber bundle were each cut to have a length of 1 m, and side surfaces of the fibers were observed using a laser microscope (“VK-9500” manufactured by Keyence Corporation) at a magnification of 500 times. If at least one crack or split was observed in the surfaces of the fibers, the result is shown as “Yes”.

### Touch

Sensory evaluation by professional hairstylists was performed in three stages below.

A: Very good touch similar to that of human hair
B: Good touch although it is slightly poor compared with that of human hair
C: Bad touch that is poor compared with that of human hair

### Example 1

30 parts by weight of a brominated epoxy-based flame retardant (product name “SR-T2MP” manufactured by Sakamoto Yakuhin Kogyo Co., Ltd.) and 3 parts by weight of sodium antimonate (product name “SA-A” manufactured by NIHON SEIKO CO., LTD.) were added to 100 parts by weight of polyethylene terephthalate pellets (EastPET product name “A-12” manufactured by East West Chemical Private Limited, hereinafter also referred to as “PET”), the mixture was dry blended, then supplied to a twin-screw extruder, melt-kneaded at a barrel setting temperature of 280° C., and pelletized, and thus a polyester-based resin composition was obtained.

Next, 12 parts by weight of a brominated epoxy-based flame retardant (product name “SR-T2MP” manufactured by Sakamoto Yakuhin Kogyo Co., Ltd.) and 2 parts by weight of sodium antimonate (product name “SA-A” manufactured by NIHON SEIKO CO., LTD.) were added to 100 parts by weight of Nylon 6 (product name “A1030BRL” manufactured by UNITIKA LTD. , hereinafter also referred to as “PA6”), the mixture was dry blended, then supplied to a twin-screw extruder, melt-kneaded at a barrel setting temperature of 260° C., and pelletized, and thus a polyamide-based resin composition was obtained.

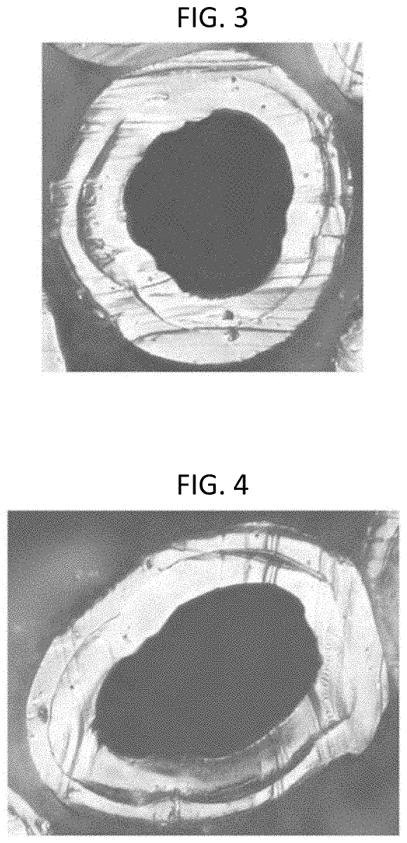

Next, the polyester-based resin composition and the polyamide-based resin composition in the form of pellets were supplied to extruders, extruded from a hollow nozzle for core-sheath conjugate spinning (set temperature: 270° C.) having a shape shown in Table 1 below, and wound up at a speed of 40 to 200 m/min, and thus undrawn yarns of core-sheath conjugate fibers each including a core part comprised of the polyester-based resin composition and a sheath part comprised of the polyamide-based resin composition, having a core-to-sheath area ratio of core:sheath=5:5 and a hollow part percentage of 20%, and of which both the core part and the fiber had circular cross sectional shapes were obtained (FIG. 3).

The obtained undrawn yarns were drawn to 3 times while being wound up at a speed of 45 m/min using a heat roll at 85° C., and subsequently heat-treated by being wound up at a speed of 45 m/min using a heat roll heated to 200° C. After application of a polyether-based oil solution (product name “KWC-Q” manufactured by Marubishi Oil Chemical Corporation) in an amount of 0.20% omf (by oil pure weight percentage with respect to the dry fiber weight), the yarns were dried, and thus a core-sheath conjugate fiber having a core-to-sheath area ratio of core:sheath=5:5, a hollow part percentage of 20%, and a single fiber fineness shown in Table 1 below, and of which both the core part and the fiber had circular cross sectional shapes was obtained.

### Example 2

A core-sheath conjugate fiber was obtained in a similar way to that of Example 1, except that the core-to-sheath area ratio was changed to core:sheath=4:6 and the hollow part percentage was changed to 10%.

### Example 3

A core-sheath conjugate fiber was obtained in a similar way to that of Example 1, except that the core-to-sheath area ratio was changed to core:sheath=2:8 and the hollow part percentage was changed to 30%.

### Example 4

A core-sheath conjugate fiber was obtained in a similar way to that of Example 1, except that the core-to-sheath area ratio was changed to core:sheath=8:2 and the hollow part percentage was changed to 40%.

### Example 5

A core-sheath conjugate fiber was obtained in a similar way to that of Example 1, except that a hollow nozzle for core-sheath conjugate spinning having a shape shown in Table 1 below was used (FIG. 4).

### Example 6

A core-sheath conjugate fiber was obtained in a similar way to that of Example 1, except that the resin used for the sheath part was changed to Nylon 66 (product name “AMILAN CM3001” manufactured by Toray Industries, Inc., hereinafter also referred to as “PA66”).

### Example 7

A core-sheath conjugate fiber was obtained in a similar way to that of Example 1, except that the core-to-sheath area ratio was set to core:sheath=5:5, the hollow part percentage was changed to 7%, and a hollow nozzle for core-sheath conjugate spinning having a shape shown in Table 1 below was used.

### Comparative Example 1

A core-sheath conjugate fiber was obtained in a similar way to that of Example 1, except that the hollow part percentage was changed to 0%.

### Comparative Example 2

A core-sheath conjugate fiber was obtained in a similar way to that of Example 1, except that the hollow part percentage was changed to 5%.

### Comparative Example 3

A core-sheath conjugate fiber was obtained in a similar way to that of Example 1, except that the hollow part percentage was changed to 50%.

### Comparative Example 4

A polyester-based resin composition was produced in a similar way to that of Example 1, the obtained polyester-based resin composition in the form of pellets was supplied to an extruder, and extruded from a hollow nozzle (set temperature: 270° C.) having a shape shown in Table 1 below, and the extruded yarns were wound up at a speed of 40 to 200 m/min, and thus undrawn yarns of fibers each having a hollow part percentage of 20% and a circular cross sectional shape were obtained.

The obtained undrawn yarns were drawn to 3 times while being wound up at a speed of 45 m/min using a heat roll at 85° C., and subsequently heat-treated by being wound up at a speed of 45 m/min using a heat roll heated to 200° C. After application of a polyether-based oil solution (product name “KWC-Q” manufactured by Marubishi Oil Chemical Corporation) in an amount of 0.20% omf (by oil pure weight percentage with respect to the dry fiber weight), the yarns were dried, and thus a fiber having a single fiber fineness shown in Table 1 below was obtained.

### Comparative Example 5

A core-sheath conjugate fiber was obtained in a similar way to that of Example 1, except that the core-to-sheath area ratio was changed to core:sheath=1:9.

### Comparative Example 6

A core-sheath conjugate fiber was obtained in a similar way to that of Example 1, except that the core-to-sheath area ratio was changed to core:sheath=9:1.

The cross sectional shapes of the fibers of the examples and the comparative examples were observed and evaluated as described above. Also, in the examples and the comparative examples, whether or not yarn breakage occurred, the presence or absence of cracks or splits in the fibers, voluminousness, the curl setting property, and touch were evaluated as described above. Table 1 shows the results.

TABLE 1

| | Example | | | | | | | Comparative Example | | | | | |
|---|---|---|---|---|---|---|---|---|---|---|---|---|---|
| | 1 | 2 | 3 | 4 | 5 | 6 | 7 | 1 | 2 | 3 | 4 | 5 | 6 |
| Nozzle shape (fiber) | Circle | Circle | Circle | Circle | Ellipse | Circle | Ellipse | Circle | Circle | Circle | Circle | Circle | Circle |
| Nozzle shape (core part) | Circle | Circle | Circle | Circle | Ellipse | Circle | Ellipse | Circle | Circle | Circle | | Circle | Circle |
| Nozzle shape (hollow | Circle | Circle | Circle | Circle | Ellipse | Circle | Ellipse | | Circle | Circle | Circle | Circle | Circle |
| part) | | | | | | | | | | | | | |
| Main component resin | PET | PET | PBT | PET | PET | PET | PET | PET | PET | PET | PET | PET | PET |
| (core) | | | | | | | | | | | | | |
| Main component resin | PA6 | PA6 | PA6 | PA6 | PA6 | PA66 | PA6 | PA6 | PA6 | PA6 | | PA6 | PA6 |
| (sheath) | | | | | | | | | | | | | |
| Core-to-sheath ratio (area | 5:5 | 4:6 | 2:8 | 8:2 | 5:5 | 5:5 | 5:5 | 5:5 | 5:5 | 5:5 | | 1:9 | 9:1 |
| ratio) | | | | | | | | | | | | | |
| Hollow part percentage | 20 | 10 | 30 | 40 | 20 | 20 | 7 | 0 | 5 | 50 | 20 | 20 | 20 |
| Single fiber fineness | 60 | 65 | 70 | 55 | 70 | 60 | 60 | 60 | 50 | 60 | 60 | 70 | 50 |
| (dtex) | | | | | | | | | | | | | |
| Yarn breakage | No | No | No | No | No | No | No | No | No | Yes | No | No | No |
| Crack, split | No | No | No | No | No | No | No | No | No | No | No | Yes | Yes |
| Voluminousness | A | B | B | A | A | A | A | C | C | | A | B | A |
| Curl setting property | A | B | A | A | B | A | A | C | C | | A | C | A |
| Touch | A | A | B | B | A | B | A | B | B | | C | C | C |

As can be seen from Table 1, spinning stability of the fibers of Examples 1 to 7 was excellent, no crack and split were formed in the fibers, and the fibers had good voluminousness, good curl setting property, and a touch close to that of human hair.

On the other hand, in the cases of the fiber of Comparative Example 1, which did not include the hollow part, and the fiber of Comparative Example 2, which had a low hollow part percentage, voluminousness and the curl setting property were poor. On the other hand, spinning stability was impaired when the hollow part percentage was too high as in Comparative Example 3. In the case of the fiber of Comparative Example 4, which did not have a core-sheath structure and was constituted only by PET, voluminousness and the curl setting property were good, but the touch was very poor. In the case of the fiber of Comparative Example 5, in which the core-to-sheath area ratio was 1:9 and the ratio of the core part was extremely low, the fiber surface had a crack and a split, and moreover, the curl setting property and touch were poor. In the case of the fiber of Comparative Example 6, in which the core-to-sheath area ratio was 9:1 and the ratio of the sheath part was extremely low, the fiber surface had a crack and a split, and moreover, the touch was poor.

One or more embodiments of the present invention may include at least the following embodiments, although there is no particular limitation thereto.

[1] A core-sheath conjugate fiber for artificial hair including a core part and a sheath part,

wherein the core part is comprised of a polyester-based resin composition that contains a polyester-based resin, and the sheath part is comprised of a polyamide-based resin composition that contains a polyamide-based resin,

the core-sheath conjugate fiber for artificial hair has a core-to-sheath area ratio of core:sheath=2:8 to 8:2, and

the core-sheath conjugate fiber for artificial hair includes a hollow part, and in a fiber cross section, the area of the hollow part constitutes 7% or more and 40% or less of the area of the fiber cross section.

[2] The core-sheath conjugate fiber for artificial hair according to [1], wherein both the core part and the hollow part are concentrically arranged.

[3] The core-sheath conjugate fiber for artificial hair according to [1] or [2], wherein the core-sheath conjugate fiber for artificial hair, the core part, and the hollow part all have elliptical cross sectional shapes.

[4] The core-sheath conjugate fiber for artificial hair according to any one of [1] to [3], wherein the polyester-based resin composition contains one or more of polyester-based resins selected from the group consisting of polyalkylene terephthalate and a copolymerized polyester mainly containing polyalkylene terephthalate.

[5] The core-sheath conjugate fiber for artificial hair according to any one of [1] to [4], wherein the polyamide-based resin composition contains a polyamide-based resin mainly containing at least one selected from the group consisting of Nylon 6 and Nylon 66.

[6] A hair ornament product including the core-sheath conjugate fiber for artificial hair according to any one of [1] to [5].

[7] The hair ornament product according to [6], wherein the hair ornament product is one selected from the group consisting of a hair wig, a hairpiece, weaving hair, a hair extension, braided hair, a hair accessory, and doll hair.

[8] A method for producing the core-sheath conjugate fiber for artificial hair according to any one of [1] to [5], including a step of melt spinning the polyester-based resin composition and the polyamide-based resin composition using a core-sheath conjugate nozzle.

### LIST OF REFERENCE NUMERALS

1, 41 Core-sheath conjugate fiber for artificial hair (cross section)

10, 50 Core part

20, 60 Sheath part

30, 70 Hollow part

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. A core-sheath conjugate fiber for artificial hair comprising:
a core part; and
a sheath part,
wherein:
the core part is comprised of a polyester-based resin composition that comprises a polyester-based resin, and the sheath part is comprised of a polyamide-based resin composition that comprises a polyamide-based resin,
the core-sheath conjugate fiber for artificial hair has a core-to-sheath area ratio of core:sheath=2:8 to 8:2,
the core-sheath conjugate fiber for artificial hair includes a hollow part, and in a fiber cross section, an area of the hollow part constitutes 7% or more and 40% or less of an area of the fiber cross section, and
both the core part and the hollow part are concentrically arranged.

2. The core-sheath conjugate fiber for artificial hair according to claim 1, wherein the core-sheath conjugate fiber for artificial hair, the core part, and the hollow part all have elliptical cross sectional shapes.

3. The core-sheath conjugate fiber for artificial hair according to claim 1, wherein the polyester-based resin composition comprises one or more of polyester-based resins selected from the group consisting of polyalkylene terephthalate and a copolymerized polyester mainly containing polyalkylene terephthalate.

4. The core-sheath conjugate fiber for artificial hair according to claim 1, wherein the polyamide-based resin mainly contains at least one selected from the group consisting of Nylon 6 and Nylon 66.

5. The core-sheath conjugate fiber for artificial hair according to claim 1, wherein the core-sheath conjugate fiber for artificial hair has a single fiber fineness of 10 dtex or more and 150 dtex or less.

6. A hair ornament product comprising the core-sheath conjugate fiber for artificial hair according to claim 1.

7. The hair ornament product according to claim 6, wherein the hair ornament product is one selected from the group consisting of a hair wig, a hairpiece, weaving hair, a hair extension, braided hair, a hair accessory, and doll hair.

8. The hair ornament product according to claim 6, wherein the core-sheath conjugate fiber for artificial hair, the core part, and the hollow part all have elliptical cross sectional shapes.

9. The hair ornament product according to claim 6, wherein the polyester-based resin composition comprises one or more of polyester-based resins selected from the group consisting of polyalkylene terephthalate and a copolymerized polyester mainly containing polyalkylene terephthalate.

10. The hair ornament product according to claim 6, wherein the polyamide-based resin mainly contains at least one selected from the group consisting of Nylon 6 and Nylon 66.

11. The hair ornament product according to claim 6, wherein the core-sheath conjugate fiber for artificial hair has a single fiber fineness of 10 dtex or more and 150 dtex or less.

12. A method for producing the core-sheath conjugate fiber for artificial hair according to claim 1, comprising a step of melt spinning the polyester-based resin composition and the polyamide-based resin composition with a core-sheath conjugate nozzle.
